(19) United States
(12) Patent Application Publication
(10) Pub. No.: US 2026/0236035 A1
(43) Pub. Date: Aug. 13, 2026

(54) MULTI-SENSOR VEHICLE COMPONENT ORIENTATION MEASUREMENT

(71) Applicant: Built Robotics Inc., San Francisco, CA (US)

(72) Inventors: Noah Austen Ready-Campbell, Littleton, NH (US); Andrew Xiao Liang, New York, NY (US); Liam Osler, San Francisco, CA (US); Emily Corser, Cleveland (AU)

(21) Appl. No.: 19/048,369

(22) Filed: Feb. 7, 2025

(51) Int. Cl. G05D 1/646; G01S 19/40; G01S 19/43; G05D 1/248; G05D 109/10; G05D 111/30

(52) U.S. Cl. CPC G05D 1/646; G01S 19/40; G01S 19/43; G05D 1/248; G05D 2109/10; G05D 2111/30

(57) ABSTRACT

An autonomous vehicle (AV) may include a vehicle body with a first real-time kinematic positioning (RTK) global positioning system (GPS) transceiver. The AV may include a pivotable vehicle component with a second RTK GPS transceiver. The AV may include a controller configured to access first location information of the first RTK GPS transceiver and second location information of the second RTK GPS transceiver, access correction information received from a local base station, determine a first heading corresponding to the vehicle body based on the first location information and the correction information, determine a second heading corresponding to the pivotable vehicle component based on the second location information and the correction information, determine an orientation of the pivotable vehicle component relative to the vehicle body, and autonomously perform a vehicle movement based on the determined orientation. The AV may be an agriculture, mining, construction, forestry, or transportation type of autonomous vehicle.

### TECHNICAL FIELD

This disclosure relates to autonomous vehicles, and, more specifically, to a system of vehicle component orientation measurement.

### BACKGROUND

Heavy equipment vehicles such as backhoes, loaders, and excavators may be used to perform a variety of earthwork operations (e.g., pile driving, drilling, excavating, digging, jackhammering, demolishing, and the like). Currently, operation of these vehicles is very expensive as each vehicle requires a manual operator on the vehicle during the entire earthwork operation. Another complication stems from an insufficient labor force skilled enough to meet the demand for operating these vehicles. Because these vehicles must be operated manually, the operations can only be performed during the day, extending the duration of projects, and further increasing overall costs. Also, dependence of current vehicles on manual operators increases the risk of human error during operations and reduces the quality of work done at the site.

### SUMMARY

In one aspect, the techniques described herein relate to an autonomous vehicle (AV), including: a vehicle body including a first real-time kinematic positioning (RTK) global positioning system (GPS) transceiver; a vehicle component including a second RTK GPS transceiver, the vehicle body and the vehicle component coupled via a pivoting joint; and a controller configured to: access first location information received from the first RTK GPS transceiver and second location information received from the second RTK GPS transceiver; access correction information received from a local base station; determine a first heading corresponding to the vehicle body based on the first location information and the correction information; determine a second heading corresponding to the vehicle component based on the second location information and the correction information; determine an orientation of the vehicle component relative to the vehicle body using the determined first heading and the determined second heading; and autonomously perform a vehicle movement based on the determined orientation.

In another aspect, the techniques described herein relate to a method of operating an autonomous vehicle (AV), the method including: receiving, from a first RTK GPS transceiver of a vehicle body, first location information; receiving, from a second RTK GPS transceiver of a vehicle component, second location information; receiving, from a local base station, correction information; accessing the first location information, the second location information, and the correction information; determining a first heading corresponding to the vehicle body based on the first location information and the correction information; determining a second heading corresponding to the vehicle component based on the second location information and the correction information; determining an orientation of the vehicle component relative to the vehicle body using the determined first heading and the determined second heading; and autonomously performing a vehicle movement based on the determined orientation.

In yet another aspect, the techniques described herein relate to a system including: a processor; and a non-transitory computer-readable storage medium including stored instructions, the instructions when executed by the processor cause to processor to perform operations including: receiving, from a first RTK GPS transceiver of a vehicle body, first location information; receiving, from a second RTK GPS transceiver of a vehicle component, second location information; receiving, from a local base station, correction information; accessing the first location information, the second location information, and the correction information; determining a first heading corresponding to the vehicle body based on the first location information and the correction information; determining a second heading corresponding to the vehicle component based on the second location information and the correction information; determining an orientation of the vehicle component relative to the vehicle body using the determined first heading and the determined second heading; and autonomously performing a vehicle movement based on the determined orientation.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates an autonomous off-road vehicle (AOV) system environment, according to some embodiments.

FIG. 2A illustrates one perspective view of one exemplary design of the AOV of FIG. 1, in accordance with some embodiments.

FIG. 2B illustrates another perspective view of the exemplary design of the AOV of FIG. 2A, in accordance with some embodiments.

FIG. 3A is a block diagram of the AOV of FIG. 1, in accordance with some embodiments.

FIG. 3B is a block diagram of the control system of the AOV of FIG. 3A, in accordance with some embodiments.

FIG. 4 illustrates a perspective view of another exemplary design of the AOV of FIG. 1, in accordance with some embodiments.

FIG. 5 illustrates a perspective view of yet another exemplary design of the AOV of FIG. 1, in accordance with some embodiments.

FIG. 6 illustrates a perspective view of yet another exemplary design of the AOV of FIG. 1, in accordance with some embodiments.

FIG. 7 illustrates a perspective view of yet another exemplary design of the AOV of FIG. 1, in accordance with some embodiments.

FIG. 8 is a flow chart illustrating a process of autonomously performing a vehicle movement based on detected vehicle component orientation data, in accordance with some embodiments.

FIG. 9 is a block diagram illustrating components of an example machine for reading and executing instructions from a machine-readable medium, in accordance with one or more example embodiments.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

This disclosure pertains to autonomous vehicles (AVs), including autonomous off-road vehicles (AOVs) for performing various autonomous operations. As used herein, “AOV” refers to any vehicle, apparatus, multi-unit system, or robot, that moves and/or operates autonomously. The AOVs are configured to operate on paved surfaces as well as in off-road environments (e.g., on surfaces other than paved roadway). The AOVs may include any tracked vehicle, construction vehicle, robot, tractor, excavator, bulldozer, transport vehicle, delivery vehicle, distribution vehicle, and the like. Example off-road environments include solar farms, dirt roads, fields, agricultural sites, rocky or gravel terrain, construction sites, forest or wooded sites, hill or mountain trails or sites, underground sites, indoor sites, rooftops, and the like. As used herein, “autonomous” refers to the ability of the off-road vehicle to operate without constant human supervision, for instance enabling the off-road vehicle to move, navigate, perform a function, and/or make a decision without explicitly receiving instructions from a human operator.

Pile driving operations involve driving piles into the ground to build structures supported on top of the piles. Piles (e.g., stakes, rebars, piers, poles, posts, beams, etc.) may be of different types based on features like length, dimensions, shape or design, bolt hole pattern, material, weight, thickness or steel gauge, and the like. Non-limiting examples of different pile designs or shapes include ground screws, helical piles, c-channel piles, sheet piles, wide flange beam piles, H-beam piles, I-beam piles. Non-limiting examples of different pile materials include metal, wood, concrete, precast concrete, reinforced concrete, synthetic material, and the like. Each pile type (having a specific configuration or set of characteristics) may have a corresponding color code or other identification code. As used herein, “ground” may refer to any earth or non-earth substrate where piles are to be installed. For example, a large collection (e.g., hundreds, thousands, tens of thousands, etc.) of photovoltaic (PV) solar panels may be installed in a geographic area to create a solar farm by driving a large number of piles into the ground, mounting individual solar panels on top of the driven piles, and electrically interconnecting the solar panels to generate large amounts of electricity from solar power. Techniques disclosed herein look to automate the pile driving process by operating an autonomous pile driving system or AOVs (e.g., an AOV or a fleet of multiple AOVs operating simultaneously and communicating with a central server) that are configured to perform a plurality of autonomous operations related to pile driving (e.g., path planning operation, navigation operation, pile basket assembly operation, pile basket loading operation, pile basket distribution operation, pile distribution operation, pile loading operation, pile positioning operation, pile driving operation, obstacle map creation operation, quality control operation, pile removal operation, and the like).

Certain systems and methods disclosed herein look to automate the process of driving a plurality of piles at respective locations into the ground using one or more AOVs (e.g., autonomous pile driving system) based on a pile plan map. As used herein, the “pile plan map” may be a digital representation indicating a plurality of locations in a geographic area (e.g., a lot, plot, tract, parcel of land, indoor site, elevated site, etc.) in which piles are intended to be driven and located. The pile plan map may specify locations (e.g., geolocations, geographic (x, y) or GPS coordinates) in the geographic area where the respective piles are to be driven, and the type (e.g., thickness, length, weight, shape or design, material, bolt hole pattern, etc.) of the pile to be driven at the location. For each location, the pile plan map may also specify other pile parameters (e.g., length, reveal height, orientation, tilt, tolerance range or threshold, number of piles, type of each pile or any other type of object that is to be located at or driven into the ground in addition to the pile at the location, etc.) for driving of the pile at the location. The pile parameters in the pile plan map may thus define the intended state of the pile at the location after the installation of the pile at the location is complete. It should be noted that reference herein to the movement, manipulation, driving, adjustment, or any other manipulation of a pile can apply equally to ground screws, beams, stakes, or any other object that can be inserted into the ground.

Based on the pile plan map, the systems and methods enable the performance of the different autonomous operations. For example, based on the pile plan map, the systems and methods may perform a path planning operation for a given AOV. In the path planning operation, the systems and methods may select a set of locations, where piles are to be installed by the AOV, from among a plurality of locations indicated in the pile plan map. The set of locations may be selected to optimize predetermined criteria. For example, the set of locations may be selected to minimize navigation or driving time and/or cost, minimize greenhouse gas emissions, maximize efficiency, reduce downtime (e.g., non-pile-driving time). The set of locations may also be selected based on pile availability, based on an obstacle map, or to ensure accessibility of each location specified by the pile plan map for subsequent pile driving by the same or other AOVs.

Based on the selected set of locations, the systems and methods may perform a basket assembly operation. For example, the systems and methods may generate instructions for assembling a set of piles in a specific order based on the order in which the piles are to be driven into the ground at the selected set of locations. In some embodiments, based on the specific order for the set of piles in the generated instructions, a pile basket assembly robot (e.g., AOV) may assemble and load the set of piles that may have different pile types in the specified order into a pile set holder (e.g., basket, cartridge, housing, etc.).

In some embodiments, instead of performing the basket assembly operation, the piles of the different types may be assembled in respective baskets and loaded onto a carriage so that a pile of each type remains always accessible to the loading and/or driving tool of the AOV. In such embodiments, based on the type of pile that is to be driving into the ground at each location, the pile loading tool may be actuated at each location to corresponding baskets having one or more piles of respective types for driving into the ground. For example, at a first location where a first type of pile is to be installed, the pile loading tool may be autonomously actuated to load a pile of the first type from a location (e.g., a first basket) storing the first type of piles. And at a second location where a second type of pile is to be installed, the pile loading tool may be autonomously actuated to load a pile of the second type from a location (e.g., a second basket the same or separate from the first basket) storing the second type of piles.

The systems and methods may further be configured to perform autonomous pile driving for each location of the pile plan map. Autonomous pile driving may include an autonomous navigation operation, an autonomous end effector positioning operation, an autonomous pile pick up operation, an autonomous pile loading operation, an autonomous pile positioning operation, and an autonomous pile driving operation (performed by a same/single AOV, or by a multi-vehicle system). In the autonomous navigation operation, an AOV (which may be the same as or different from the AOV that carries the basket of the ordered set of piles) may navigate autonomously (based on a path plan determined by the path planning operation) to a first location where a first one of the set of piles in the loaded basket is to be driven.

In the autonomous end effector positioning operation, the autonomous pile pick up operation, and the autonomous pile loading operation, the pile driving AOV may autonomously position an end effector to face a pile to be picked up, autonomously pick up the pile (e.g., the first or top pile in a stack of piles in a basket) and load the pile onto a driving tool of the AOV (which may be the same as or different from the tool that picked up the pile) to drive the pile into the ground. In the autonomous pile driving operation, the AOV may autonomously drive the pile loaded onto the driving tool of the AOV into the ground. In performing the autonomous pile driving operation at the location, the AOV may utilize the pile parameters for the location included in the pile plan map and, in some embodiments, control actuation parameters of the driving tool of the AOV based on the pile parameters to achieve the intended state (e.g., pile height, plumbness, orientation, location, etc.) of the pile at the location after the autonomous pile driving operation. The AOV may then similarly perform repeated autonomous pile driving operations for subsequent locations per the path plan. A fleet of AOVs may simultaneously and continuously perform the autonomous pile driving operations at respective sets of locations from among the plurality of locations of the same pile plan map to complete large-scale pile driving projects quickly and accurately, and with high efficiency and reduced costs.

During or after the pile driving operation, the pile driving AOV (or a separate quality control AOV) may perform a quality control operation to ensure that the driving of the pile at each location complies with the corresponding pile parameters dictated by the pile plan map. For example, the AOV may operate one or more sensors at a predetermined frequency during the pile driving operation to obtain sensor data and determine whether one or more attributes of the pile (being) installed at the location are within corresponding tolerance thresholds. The one or more attributes of the pile that may be monitored based on the sensor data may include the (actual) horizontal location of the pile driven into the ground, the vertical location of the top of the pile (e.g., to detect an over-driven pile, or an under-driven pile; also referred to as reveal height), pile refusal condition, plumbness or verticality of the pile relative to ground, orientation of the pile (e.g., 3D orientation of the bolt holes of the pile), rotation or yaw of the pile relative to the ground, deformation (e.g., bend, dents, etc.) of the pile, damage (e.g., crack or other manufacturing defect) to the pile, and the like.

The quality control operation may determine performance of one or more quality control actions based on quality control condition data (e.g., pile attribute data) generated based on the determination regarding one or more of the pile attributes being outside corresponding tolerance thresholds. For example, the quality control action may be to flag the location in association with the corresponding quality control condition data in a quality control map for subsequent manual inspection. Another example of the action may be to stop the pile driving operation prior to its completion. As yet another example, the action may be to modify actuation parameters of the pile driving tool to perform corrective action during the pile driving operation to attempt to bring an offending attribute back within the corresponding tolerance threshold (e.g., change the angle of impact of the driving tool on top of the pile being driven into the ground to bring the plumbness of the pile closer to a desired plumbness as dictated by the pile parameters in the pile plan map).

Based on the pile driving operation, the systems and methods according to the present disclosure may also generate an obstacle map indicating locations of obstacles within the geographic area. As used herein, the “obstacle map” may be a digital representation indicating obstacles or objects within the geographic area. For each obstacle tagged in the map, the obstacle map may include attributes of the obstacle such as identity, type or category of the object, physical characteristics of the object, 3D location of the object, depth of the object, and the like. The obstacle map may thus convey non-navigable regions for the AOV within the geographic area and may include as-built obstacles like piles that have been installed by the AOV at locations prescribed by the pile plan map. The as-built obstacles may be added to the obstacle map based on the pile driving operation performed by the AOV. That is, in response to the pile driving operation of driving the pile at a first location, the obstacle map may be modified to include a representation of the pile at the first location. Subsequent pile driving operations at subsequent locations may result in similar modifications to the obstacle map to include representations of the piles at the subsequent locations. The representations of the piles at the respective locations may include obstacle attributes such as horizontal location of the pile, vertical location of the top of the pile, 3D discretized pile volume data, and the like. The obstacle map may also include data regarding other types of static (e.g., inverters, torque tubes, trenches, dirt piles, electric poles, etc.) or dynamic (e.g., other AOVs or vehicles, pedestrians, etc.) obstacles (e.g., non-pile obstacles). The non-pile obstacles may be added to the obstacle map perceptually based on sensor data captured by the AOV.

Techniques disclosed herein may also look to synchronize the obstacle map based on operations being performed by multiple AOVs and use the synchronized and continuously updated, dynamic obstacle map to avoid obstacles while performing the different operations by the multiple AOVs like the path planning operation, the navigation operation, the pile loading operation, AOV tool actuation operation, the pile driving operation, and the like.

### Example Autonomous Off-Road Vehicle System Environment

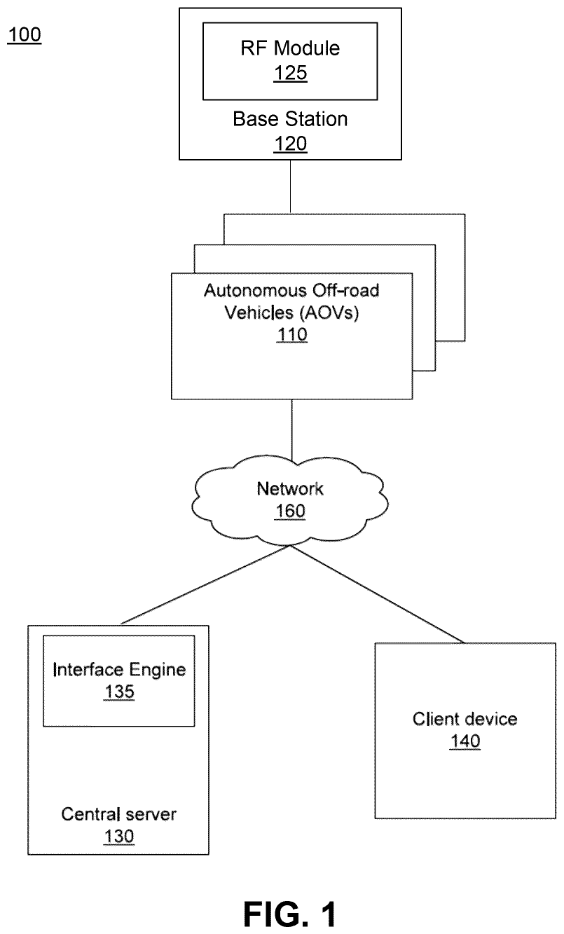

FIG. 1 illustrates an autonomous off-road vehicle system environment 100, according to some embodiments. The environment 100 of FIG. 1 includes one or more autonomous off-road vehicles 110 (“AOV” or simply “vehicle” hereinafter), a local base station 120, a central server 130, a client device 140, and a network 160. It should be noted that in other embodiments, the environment 100 may include different, fewer, or additional components than those illustrated in FIG. 1. For instance, the client device 140 and the central server 130 may be the same device. The local base station 120 may include a radio frequency (RF) module 125 for communicating with the one or more AOVs 110 independently of the network 160.

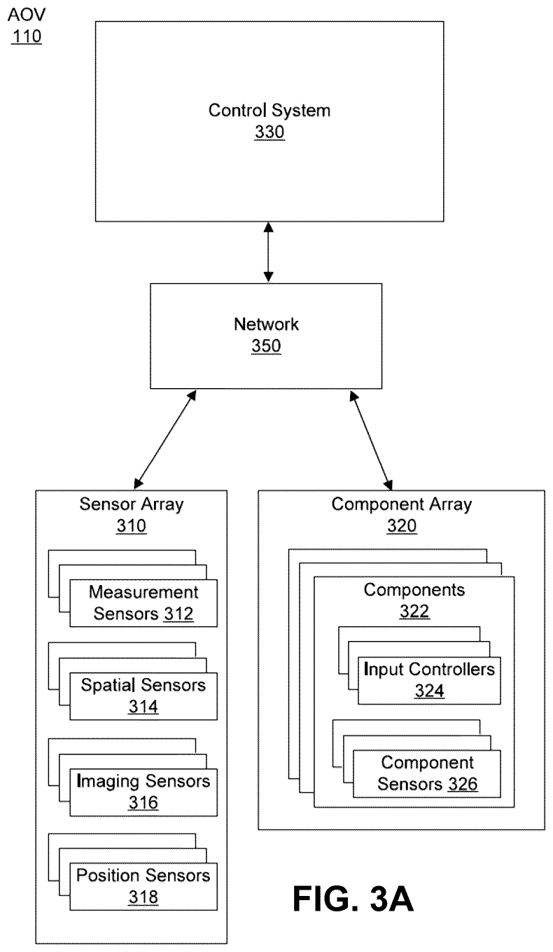

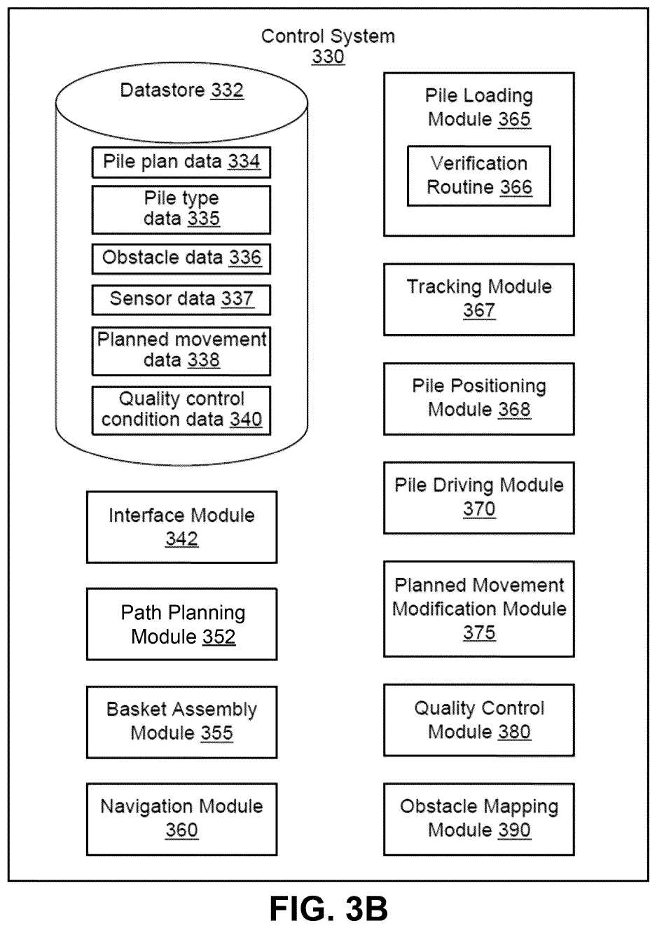

Each AOV 110 of FIG. 1 may be a vehicle (e.g., item of heavy equipment, vehicle, apparatus, system, robot, and the like) that is configured to move and/or operate autonomously and that is configured to communicate with the central server 130. Examples of AOVs 110 within the scope of this description include, but are not limited to pile loaders, pile drivers, pile driving rigs, pile distribution vehicles, pile basket assembly robots, loaders such as backhoe loaders, track loaders, wheel loaders, skid steer loaders, scrapers, graders, bulldozers, compactors, excavators, mini-excavators, trenchers, skip loaders, tracked vehicles, construction vehicles, tractors, transport vehicles, delivery vehicles, distribution vehicles, and the like. Collectively, AOVs 110 may correspond to an AOV fleet that includes one or more of each of different types of AOVs 110 that respectively have different functionality. Example embodiments and functional components of the AOV 110 are described in greater detail below in at least FIGS. 3A-3B.

The central server 130 is a computing system located remotely from the AOV 110. In some embodiments, the central server is a web server or other computer configured to receive data from and/or send data to one or more AOVs 110 within the environment 100. In some embodiments, the central server 130 receives information from the AOV 110 (e.g., obstacle data, quality control condition data, sensor data, etc.) indicating a location of the AOV 110, a result of a function or operation being performed by the AOV 110, a state of one or more vehicles, information describing the surroundings of the AOV 110, and the like. In some embodiments, the central server 130 may receive a real-time feed of data from the AOV 110, such as a real-time video feed of the environment surrounding the AOV. In some embodiments, the central server 130 can provide information to the AOV 110, such as an instruction to perform an operation or function (e.g., pile driving operation on a set of locations), a navigation instruction (such as a route), synced obstacle data, and the like. In some embodiments, the central server 130 can enable a remote operator to assume manual control of the AOV 110 and provide manual navigation or operation instructions to the AOV. In some embodiments, some of the functionality of the AOV 110 described below in connection with, e.g., FIGS. 3A-3B may be subsumed by the central server 130. For example, sensor data from the AOV 110 may be transmitted to the central server 130, and the central server 130 may subsume the functionality corresponding to one or more of the obstacle map creation operation, the quality control operation, and the like.

The central server 130 may include an interface engine 135 configured to generate one or more interfaces for viewing by a user (such as a user of the central server 130 or a user of the client device 140). The user can be a remote operator of the AOV 110, can be an individual associated with the environment 100 (such as a supervisor, a consultant, etc.), can be an individual associated with the AOV 110 (such as an operator, a repairman, an on-site coordinator, or the like), or can be any other suitable individual. The interface engine 135 can be used by a user to provide one or more instructions to an AOV 110, such as autonomous navigation instructions, operation or function instructions, remote piloting instructions, and the like. The interface engine 135 can generate a user interface displaying information associated with the AOV 110, other vehicles, or the environment 100. For instance, the user interface can include a map illustrating a location and/or movement of each of the AOVs 110 within the geographic area, a path plan generated for each AOV 110, a respective set of locations where piles will be driven by each AOV 110, a current status of the AOV 110, a remaining number and type of piles available to each AOV 110, any notifications or other data received from each AOV 11, and the like. The user interface can display notifications generated by and/or received from the AOV 110, for instance, within a notification feed, as pop-up windows, using icons within the map interface, and the like. By communicatively coupling to multiple AOVs 110, the central server 130 beneficially enables one user to track, monitor, and/or control multiple AOVs simultaneously.

The client device 140 is a computing device, such as a computer, a laptop, a mobile phone, a tablet computer, or any other suitable device configured to receive information from or provide information to the central server 130. The client device 140 includes a display configured to receive information from the interface engine 135, that may include information representative of one or more of the AOVs 110 or the environment 100. The client device 140 can also generate notifications (e.g., based on notifications generated by an AOV 110) for display to a user. The client device 140 can include input mechanisms (such as a keypad, a touch-screen monitor, and the like), enabling a user of the client device to provide instructions to a selected one of the AOVs 110 (via the central server 130). It should be noted that although the client device 140 is described herein as coupled to an AOV 110 via the central server 130, in practice, the client device 140 may communicatively couple directly to the AOV (enabling a user to receive information from or provide instructions to the AOV 110 without going through the central server 130).

As noted above, the systems or components of FIG. 1 are configured to communicate via a network 160, which may include any combination of local area and/or wide area networks, using both wired and/or wireless communication systems. In one embodiment, the network 160 uses standard communications technologies and/or protocols. For example, the network 160 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 160 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 160 may be represented using any suitable format, such as hypertext markup language (HTML) or extensible markup language (XML). In some embodiments, all or some of the communication links of the network 160 may be encrypted using any suitable technique or techniques.

### Example Autonomous Off-Road Vehicle Design

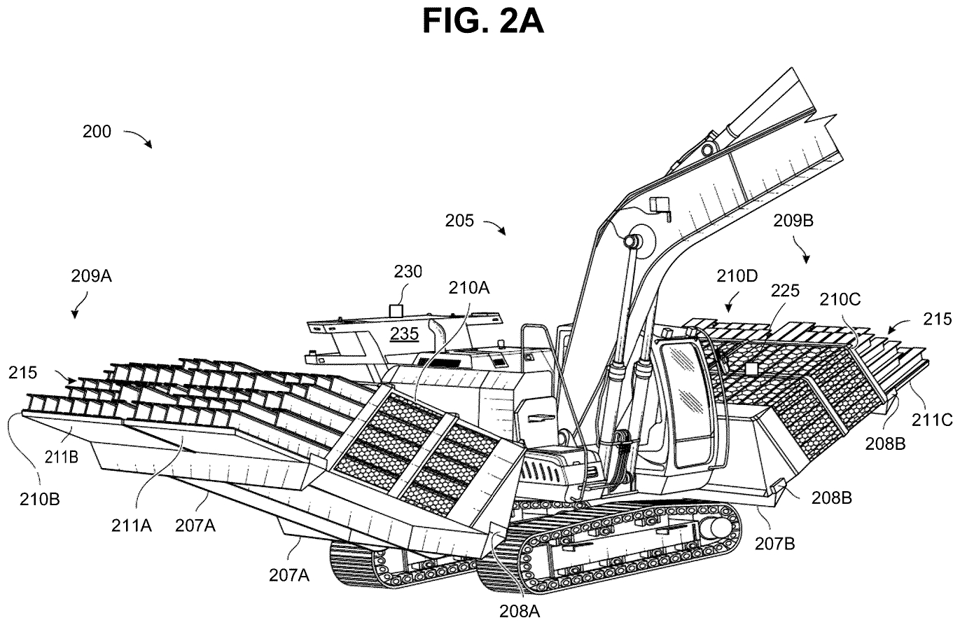

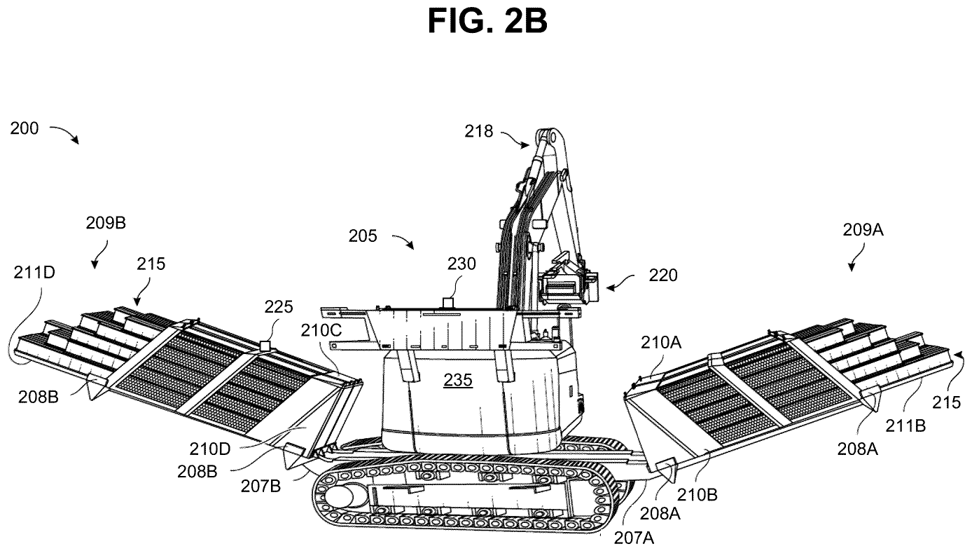

FIGS. 2A-2B show perspective views of an exemplary design of the AOV 110 of FIG. 1, in accordance with one embodiment. More specifically, FIGS. 2A-2B illustrate an exemplary design of a pile platform (e.g., basket, pile set holder, pile set bundle, cartridge, and the like) 210 (210A, 210B, 210C, 210D) of a pile driving AOV 200. It should be emphasized that although description is made herein with regards to the transport, carrying, and driving of piles, in practice, the platforms described herein can carry, transport, and/or install other materials, such as solar panels, lumber (e.g., boards, studs, framing materials), ground screws, helical piles, paving materials, and the like.

As shown in FIGS. 2A-2B, the pile driving AOV 200 includes a vehicle body 205 (e.g., main body) and platforms 210 coupled to opposite sides 209A and 209B of the vehicle body. In the embodiment shown in FIGS. 2A-2B, the AOV 200 is configured to be coupled with two platforms each on the opposite sides 209A and 209B of the vehicle body 205 (i.e., platforms 210A and 210B on side 209A and platforms 210C and 210D on side 209B). However, in other embodiments, the AOV 200 may be configured to be coupled with a different number (e.g., one, three or more) of platforms on each side. Also, in some embodiments, the number of platforms 210 coupled with the AOV 200 on one side may be different from the number of platforms 210 coupled on the other side.

In the embodiments shown in FIGS. 2A-2B, a base frame 207 including frame portions 207A, 207B is connected to and extends from opposite sides 209A, 209B of the vehicle body 205 in a cantilever manner. As shown in FIGS. 2A-2B, the base frame 207 is angled upwards and away from the vehicle body 205 and includes brackets 208A, 208B to removably mount platforms 210A-B and platforms 210C-D on the base frame 207 on the opposite sides, such that platforms 210A-B are mounted adjacent to each other on the base frame 207A on side 209A of the vehicle body 205, and platforms 210C-D are mounted adjacent to each other on the base frame 207B on side 209B of the vehicle body 205. In other embodiments, the base frame 207 may be omitted from the AOV 200 design and instead, the platforms 210 may be adapted to the directly coupled (e.g., via mounts, brackets, etc.) to the vehicle body 205 in a cantilever manner so as to achieve a configuration similar to the configuration shown in FIGS. 2A-2B.

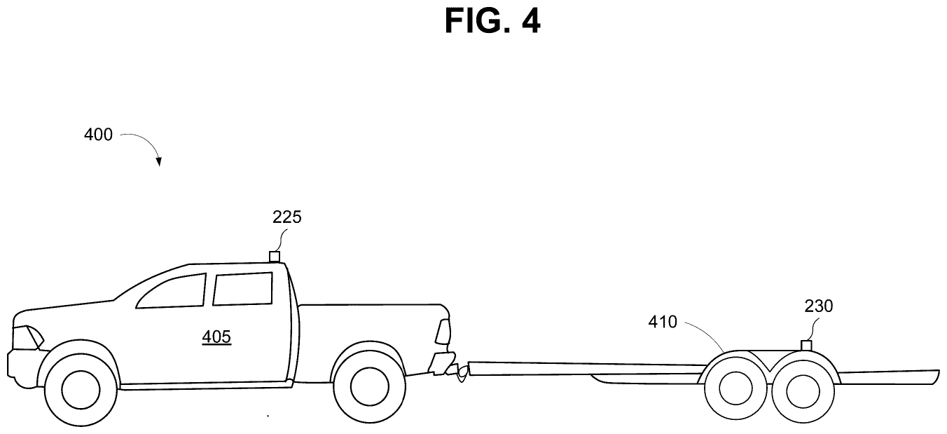

The frame portions 207A and 207B and bracket 208A and 208B may provide a structure the platforms 210 may be removably loaded onto and unloaded from. Each platform 210 houses one or more piles 215 that are to be driven into the ground by the AOV 200. The platform 210 is a modular component that is removably loaded (i.e., removably mountable) on and supported by the base frame 207 and the brackets 208. For example, the platform 210 including a plurality of piles may be assembled separately and the assembled platform 210 may be loaded onto the base frame 207 by another vehicle (e.g., any of the vehicles as illustrated in FIGS. 4-7).

The base frame 207 may be structured such that a first end of each frame portion 207A-207B is connected to the vehicle body and a second distal end of each frame portion 207A-207B is at an elevated position relative to the first end. As shown in FIGS. 2A-2B, the frame portions 207A and 207B are supported by the vehicle body 205 in a cantilever manner such that only the first ends of frame portions 207A and 207B are supported. Further, as shown in FIGS. 2A-2B, by being placed on the upward angled base frame 207, each platform 210 is arranged such that a base 211 (211A, 211B, 211C, 211D) of each platform 210 is angled upwards and away from the vehicle body 205.

Having the upward angle between the first and second ends of the frame portion (or between corresponding first and second ends of the platform mounted thereon) allows the platform 210 with a plurality of piles to be easily loaded onto the base frame without any of the piles 215 falling out of the platform. The upward angle also ensures that the pile platform 210 remains firmly secured on the base frame 207 of the AOV 200 while the AOV 200 is operating to perform the various operations described herein. The upward angle also renders optional the provision of any additional mechanism to secure the platforms 210 onto the AOV 200 or to secure the piles 215 in each platform 210. The upward angle further allows only the intended pile 215 to be picked up and slide out of the platform 210 during the autonomous loading operation without causing any other pile 215 that is adjacent to or under the target pile from sliding out along with the pile 215 being handled. The upward angle can be any suitable angle, so long as the operations described herein including the pile platform loading operation, pile transport operation, the pile loading operation, pile driving operation, and the like, can be performed without causing the platform 210 or individual piles 215 to unintentionally move or fall out.

In the embodiments shown in FIGS. 2A-2B, each platform 210 is depicted as a basket having five closed sides and a sixth open side. That is, each platform 210 is depicted as having a first closed end in a longitudinal direction thereof and a second open end, where the pile is picked up from the platform 210 from the second open end. In other embodiments, platform 210 may have a different design. Any suitable design can be used that is consistent with the disclosure.

In the embodiment shown in FIGS. 2A-2B, a vehicle tool 220 (e.g., driving tool) mounted to the articulated arm 218 of the AOV 200 may pick up a pile 215 from the sixth open side of the basket 210 and slide it out of the basket 210 to position the pile 215 at a desired location above the ground and drive the pile 215 into the ground. More specifically, during the autonomous pile pick up and pile positioning operation, the AOV 200 may autonomously actuate (e.g., using hydraulics, pneumatics, electric motors, etc.) articulated arm 218 of the driving tool 220 to adjust position and orientation of the driving tool 220 to pick up a pile 215 from a basket 210 onto the driving tool 220, and lift and autonomously position the pile 215 at a predetermined location above the ground where the pile is to be driven. After driving the pile 215 at the location, the AOV 200 may autonomously navigate to a next location dictated by a pile plan map and repeat the autonomous pile pick up operation, the autonomous pile positioning operation, and the autonomous pile driving operation for a next pile 215 from the (same or different) basket 210.

The AOV 200 also includes a sensor assembly. For example, the sensor assembly (e.g., an object sensor system) can include cameras (e.g., camera array) that capture image data, a location sensor (e.g., GPS receiver, Bluetooth sensor), a LIDAR sensor, a RADAR sensor, kinematic sensors, weight sensors, depth sensors, proximity detectors, or any other component.

The sensor assembly may thus be configured to detect one or more of image data, location data (e.g., geolocation data) indicating a position and orientation of the AOV 200 on a map corresponding to the geographic area, a presence of objects or things within a proximity of the AOV 200, dimensions of any detected objects or things, and the like. The sensors of the sensor assembly can be mounted on one or more external surfaces or appendages of the AOV 200, can be located within the AOV 200, can be coupled to an object or surface external to the AOV 200, or can be mounted to a different vehicle (e.g., pile carriage) of the autonomous pile driving system.

In the example of FIGS. 2A-2B, the sensors of the sensor assembly include a first real-time kinematic positioning (RTK) GPS transceiver 225 and a second RTK GPS transceiver 230. The first RTK GPS transceiver 225 is mounted to the vehicle body 205 via one of the platforms 210 (e.g., the platform 210C). The second RTK GPS transceiver 230 is mounted to a pivotable vehicle component 235 which is rotatably connected to the vehicle body 205 by a pivoting joint. Location data (e.g., GPS data) of the first RTK GPS transceiver 225 and the second RTK GPS transceiver 230 may be used to determine a relative angle of rotation between the pivotable vehicle component 235 and the vehicle body 205. In the example of the pile driving AOV 200, the relative angle of rotation of the pivotable vehicle component 235 is also associated with rotation of the articulated arm 218 and driving tool 220.

Although the first RTK GPS transceiver 225 is illustrated as being mounted to the platform 210C, the transceiver 225 may be mounted directly to the vehicle body 205, base frame 207, bracket 208, platform 210, platform base 211, or any other vehicle component which is fixedly connected to the vehicle body 205. The first RTK GPS transceiver 225 and the second RTK GPS transceiver 230 may be mounted to upper external surfaces of the vehicle body 205 and the pivotable vehicle component 235 to facilitate optimal satellite connectivity. In some cases, the sensor assembly may further include external antennas (e.g., an antenna array) communicatively connected to the first RTK GPS transceiver 225 and/or the second RTK GPS transceiver 230.

The exemplary design of the pile driving AOV 200 shown in FIGS. 2A-2B are for ease of illustration and explanation only and are not intended to be limiting. As will be discussed herein with reference to FIGS. 4-7, any suitable design for the AOV 110 is encompassed within the scope of this disclosure so long as the design can perform one or more of the functions or operations described herein. It should also be emphasized that although the orientation-determination system herein is described in conjunction with an autonomous pile driving system, in practice, the system can be used to determine the orientation of any vehicle component relative to a different vehicle component, and is not limited to pile driving embodiments.

It should be noted that in some embodiments, the AOV 110 can include a prismatic or telescoping joint, and the AOV can determine a position or location of a portion of the AOV coupled to the joint (including a portion of the prismatic or telescoping joint) using the sensors (such as the first RTK GPS transceiver 225 and the second RKT GPS transceiver 230) according to the principles described herein.

### Example Pile Driving AOV Configuration

FIG. 3A is a block diagram of the AOV 110 of FIG. 1, in accordance with some embodiments. As shown in FIG. 3A, the AOV 110 includes a sensor array 310, a component array 320, and a control system 330, each communicatively coupled via a network 350. It should be noted that in other embodiments, the AOV 110 may include different, fewer, or additional components than those illustrated in FIG. 3.

The sensor array 310 (e.g., object sensor system) includes a combination of one or more of: measurement sensors 312, spatial sensors 314, imaging sensors 316, and position sensors 318 (e.g., the first RTK GPS transceiver 225 and second RTK GPS transceiver 230).

The sensor array 310 is configured to collect data related to the AOV 110 and environmental data surrounding the AOV 110. The control system 330 is configured to receive the data from the AOV 110 and carry out instructions based on the received data to perform various autonomous operations (e.g., path planning operation, navigation operation, pile basket assembly operation, pile basket loading operation, pile basket distribution operation, pile distribution operation, end effector positioning operation, pile pick up operation, pile loading operation, pile positioning operation, pile driving operation, obstacle map creation operation, quality control operation, pile removal operation, etc.). Each sensor is either removably mounted to the AOV 110 without impeding the operation of the AOV 110 or is an integrated component that is a native part of the AOV 110 as made available by its manufacturer. Each sensor transmits the data in real-time or as soon as a network connection is achieved, automatically without input from the AOV 110 or a human operator. Data recorded by the sensor array 310 is used by the control system 330 and/or the central server 130 of FIG. 1 to perform the various autonomous operations.

Measurement sensors 312 generally measure properties of the ambient environment, or properties of the AOV 110 itself. These properties may include tool position/orientation, relative articulation of the various joints of the arm supporting the tool, vehicle speed, ambient temperature, hydraulic pressure (either relative to capacity or absolute) including how much hydraulic capacity is being used by the drive system and the driving tool separately. A variety of possible measurement sensors 312 may be used, including hydraulic pressure sensors, linear encoders, radial encoders, inertial measurement unit sensors, incline sensors, accelerometers, strain gauges, gyroscopes, and string encoders.

The spatial sensors 314 output a three-dimensional map in the form of a three-dimensional point cloud representing distances, for example between one meter and fifty meters between the spatial sensors 314 and the ground surface or any objects within the field of view of the spatial sensor 314, in some cases per rotation of the spatial sensor 314. In one embodiment, spatial sensors 314 include a set of light emitters (e.g., Infrared (IR)) configured to project structured light into a field near the AOV 110, a set of detectors (e.g., IR cameras), and a processor configured to transform data received by the infrared detectors into a point cloud representation of the three-dimensional volume captured by the detectors as measured by structured light reflected by the environment. In one embodiment, the spatial sensor 314 is a LIDAR sensor having a scan cycle that sweeps through an angular range capturing some or all of the volume of space surrounding the AOV 110. Other types of spatial sensors 314 may be used, including time-of-flight sensors, ultrasonic sensors, and radar sensors.

Imaging sensors 316 capture still or moving-video representations of the ground surface, objects, and environment surrounding the AOV 110. Example imaging sensors 316 include, but are not limited to, stereo RGB cameras, structure from motion cameras, and monocular RGB cameras. In one embodiment, each camera can output a video feed containing a sequence of digital photographic images at a rate of 20 Hz. In one embodiment, multiple imaging sensors 316 are mounted such that each imaging sensor captures some portion of the entire 360-degree angular range around the vehicle. For example, front, rear, left lateral, and right lateral imaging sensors may be mounted to capture the entire angular range around the AOV 110.

The position sensors 318 provide a position of the AOV 110. This may be a localized position within a geographic area, or a global position with respect to latitude/longitude, or some other external reference system. In one embodiment, a position sensor is a global positioning system interfacing with a static local ground-based GPS node mounted to the AOV 110 to output a position of the AOV 110. In the preferred embodiment, the position sensors 318 include the first RTK GPS transceiver 225 and the second RTK GPS transceiver 230 for determining a relative angle of rotation between the vehicle body 205 and the pivotable vehicle component 235.

There are a number of different ways for the sensor array 310 generally and the individual sensors specifically to be constructed and/or mounted to the AOV 110. This will also depend in part on the design or construction of the AOV 110. The number, location, type or mounting position of the sensors for the AOV 110 is not intended to be limiting, so long as the sensors can operate to enable the autonomous operations described.

Generally, individual sensors as well as the sensor array 310 itself range in complexity from simplistic measurement devices that output analog or electrical systems electrically coupled to a network bus or other communicative network, to more complicated devices which include their own onboard computer processors, memory, and the communications adapters. Regardless of construction, the sensors and/or sensor array together function to record, store, and report information to the control system 330. Any given sensor may record, or the sensor array may append to recorded data time stamps for when data was recorded.

The sensor array 310 may include its own network adapter (not shown) that communicates with the control system 330 either through either a wired or wireless connection. For wireless connections, the network adapter may be a Bluetooth Low Energy (BTLE) wireless transmitter, infrared, or 802.11 based connection. For wired connection, a wide variety of communications standards and related architecture may be used, including Ethernet, a Controller Area Network (CAN) Bus, or similar. In the case of a BTLE connection, after the sensor array 310 and the control system 330 have been paired with each other using a BLTE passkey, the sensor array 310 automatically synchronizes and communicates sensor data to the control system 330. If the sensor array 310 has not been paired with the control system 330 prior to operation, the information is stored locally until such a pairing occurs. Upon pairing, the sensor array 310 communicates any stored data to the control system 330.

The component array 320 includes one or more components 322. The components 322 are elements of the AOV 110 that can perform different actions. Non-limiting examples of the components 322 include the articulated arm 218, the pile driving tool 220, and the pivotable vehicle component 235, as shown in FIG. 2B. Other examples of components 322 may include components for performing one or more of the various autonomous operations (e.g., path planning operation, navigation operation, pile basket assembly operation, pile basket loading operation, pile basket distribution operation, pile distribution operation, end effector positioning operation, pile pick up operation, pile loading operation, pile positioning operation, pile driving operation, obstacle map creation operation, quality control operation, pile removal operation). As illustrated in FIG. 3A, each component has one or more input controllers 324 and one or more component sensors 326, but a component may include only sensors or only input controllers. An input controller controls the function of the component. For example, an input controller may receive machine commands via the network and actuate the component in response. A component sensor 326 generates measurements within the system environment. The measurements may be of the component, the AOV 110, or the environment surrounding the AOV 110. For example, a component sensor 326 may measure a configuration or state of the component 322 (e.g., a setting, parameter, power load, etc.), measure an area surrounding the AOV (e.g., moisture, temperature, etc.), or measure a weight of a basket of piles.

The control system 330 receives information from the sensor array 310 and the component array 320, and performs operations based on an input pile plan map. For example, the control system 330 controls one or more of the components 322 based on the pile plan map to autonomously assemble an ordered set of piles that may include piles of different types into a basket of piles and load the basket of piles onto a vehicle for distribution and/or driving into the ground. As another example, the control system 330 controls one or more of the components 322 based on the pile plan map to autonomously perform the pile loading operation and the pile driving operation at a first location, and autonomously navigate to a next location based on the pile plan map to autonomously perform the pile loading operation and the pile driving operation at the next location, and so on. As another example, the control system 330 controls one or more of the components 322 based on an obstacle map to autonomously navigate to a desired location or perform AOV tool path planning (e.g., movement of articulated arm to load a pile into the driving tool) based on the pile plan map and while avoiding obstacles. Operation and functionality of the control system 330 is described in greater detail in FIG. 3B.

The network 350 connects nodes of the AOV 110 to allow microcontrollers and devices to communicate with each other. In some embodiments, the components are connected within the network as a Controller Area Network (CAN). In this case, within the network each element has an input and output connection, and the network 350 can translate information between the various elements. For example, the network 350 receives input information from the sensor array 310 and the component array 320, processes the information, and transmits the information to the control system 330. The control system 330 generates instructions to execute different steps of the different autonomous operations based on the information and transmits the instructions to carry out the steps of the autonomous operations to the appropriate component(s) 322 of the component array 320. In other embodiments, the components may be connected in other types of network environments and include other networks, or a combination of network environments with several networks. For example, the components may be connected in a network such as the Internet, a LAN, a MAN, a WAN, a mobile wired or wireless network, a private network, a virtual private network, a direct communication line, and the like.

FIG. 3B is a block diagram of the control system 330 of FIG. 3A, in accordance with some embodiments. Referring to FIG. 3B, the control system 330 includes a datastore 332, an interface module 342, a path planning module 352, a basket assembly module 355, a navigation module 360, a pile loading module 365, a tracking module 367, a pile positioning module 368, a pile driving module 370, a planned movement modification module 375, a quality control module 380, and an obstacle mapping module 390. The datastore 332 may store different types of data utilized, generated, or received by the control system 330 for performing the different autonomous operations related to pile driving. For example, the datastore 332 may store pile plan data 334, pile type data 335, obstacle data 336, sensor data 337, planned movement data 338, and quality control condition data 340. The pile loading module 365 may include a verification routine 366. In different embodiments, the control system 330 may include fewer or additional components. The control system 330 may also include different components.

Additionally, some of the data or functionality described in connection with the control system 330 may be subsumed by other components, such as the central server 130 of FIG. 1.

The interface module 342 is an interface for a user and/or a third-party software platform to interact with the control system 330. The interface module 342 may be a web application that is run by a web browser on a user device or a software as a service platform that is accessible by a user device through a network (e.g., network 160 of FIG. 1). In some embodiments, the interface module 342 may use application program interfaces (APIs) to communicate with user devices or third-party platform servers, which may include mechanisms such as webhooks.

### Additional Autonomous Off-Road Vehicle Designs

A system of multi-sensor vehicle component orientation measurement may be implemented according to various embodiments. FIGS. 4-7 illustrate additional exemplary designs of the AOV 110 including a system of multi-sensor vehicle component orientation measurement.

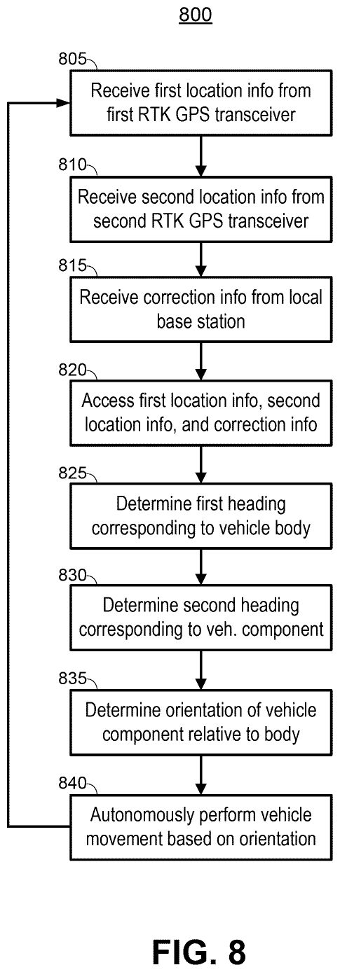

FIG. 4 illustrates a perspective view of another exemplary design of the AOV 110. In the example of FIG. 4, the AOV 110 is a truck AOV 400 towing a trailer component 410. Although illustrated as a pick-up truck towing a flatbed trailer, the truck AOV 400 may include any type of towing vehicle and trailer combination known to those skilled in the art, such as a semi-trailer truck, box truck, dump truck, fire truck, tanker truck, refrigerator truck, garbage truck, and the like. The truck AOV 400 includes a sensor assembly configured to perform multi-sensor vehicle component orientation measurement, as will be discussed below with reference to FIG. 8. The sensor assembly includes the first RTK GPS transceiver 225 mounted to a truck body 405 (e.g., the vehicle body 205) and the second RTK GPS transceiver 230 mounted to the trailer component 410 (e.g., the pivotable vehicle component 235).

As an AOV 110 (e.g., the truck AOV 400) navigates a worksite (e.g., to load or unload the pile driving AOV 200 of FIG. 2), the ability of the AOV 110 to perform vehicle path planning and execute movement operations may depend on the precise orientation (e.g., angle of rotation) of the pivotable vehicle component 235 relative to the vehicle body 205. For example, the truck AOV 400 may be unable to turn or reverse according to a planned vehicle path (e.g., a planned sequence of vehicle movement operations) when one or more preceding movement operations have resulted in the trailer component 410 being positioned at an angle of less than 120 degrees or greater than 240 degrees relative to the truck body 405. In other cases, the truck AOV 400 may be unable to turn or reverse when previous movement operations have left the trailer component 410 at an angle of less than 130, 140, or 150 degrees or greater than 230, 220, or 210 degrees relative to the truck body 405. As will be discussed herein, a controller (e.g., the control system 330) can generate and modify autonomous movement operations of the AOV 400 as needed to re-orient the trailer component 410 in anticipation of planned movement operations. In certain embodiments, modification of the vehicle path plan can occur based on real-time feedback from the first RTK GPS transceiver 225 and the second RTK GPS transceiver 230 indicative of the relative angle of rotation.

By performing multi-sensor vehicle component orientation measurement to determine the relative angle of rotation between the truck body 405 and trailer component 410, the truck AOV 400 is able to perform one or more autonomous operations (e.g., path planning operations, navigation operations, loading operations, unloading operations, positioning operations, obstacle map creation operations, quality control operations, etc.) as described herein.

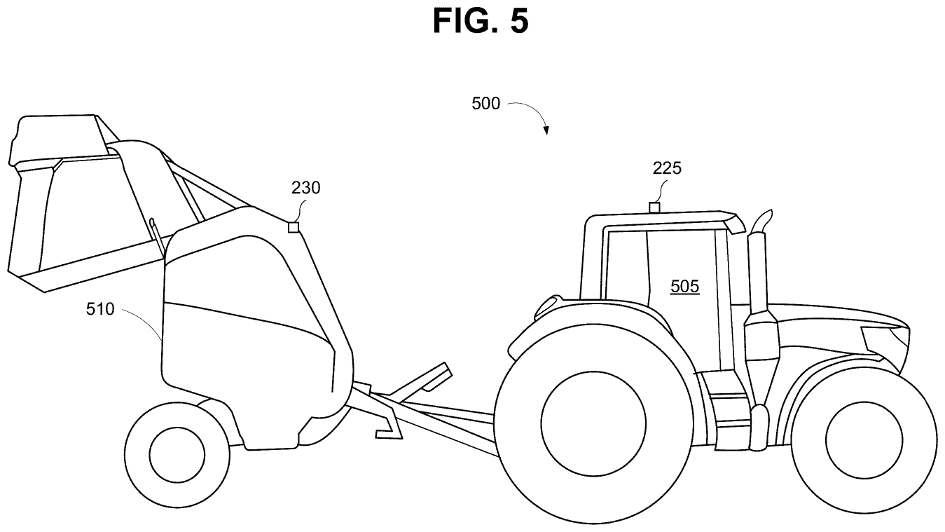

Referring now to FIG. 5, a perspective view of another exemplary design of the AOV 110 is shown. As illustrated by FIG. 5, the AOV 110 is a tractor AOV 500 towing a trailer component 510 (e.g., a baler). Although illustrated as a tractor towing a baler, the tractor AOV 500 may include any type of towing vehicle and agricultural trailer combination known to those skilled in the art, such as a planter, seeder, harvester, harrow, sprayer, mower, and the like. The tractor AOV 500 includes a sensor assembly configured for multi-sensor vehicle component orientation measurement, including a first RTK GPS transceiver 225 mounted to a tractor body 505 (e.g., the vehicle body 205) and a second RTK GPS transceiver 230 mounted to the trailer component 510 (e.g., the pivotable vehicle component 235). The tractor AOV 500 may perform vehicle path planning and execute movement operations based on real-time feedback from the first RTK GPS transceiver 225 and the second RTK GPS transceiver 230 indicative of a relative angle of rotation between the tractor body 505 and the trailer component 510, as discussed herein.

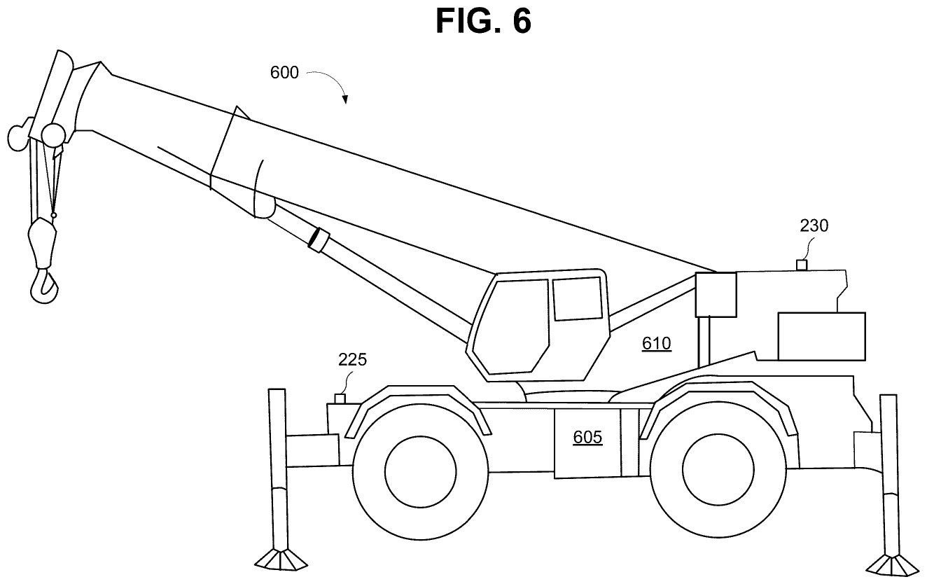

FIG. 6 illustrates a perspective view of yet another exemplary design of the AOV 110. In the embodiment of FIG. 6, the AOV 110 is a mobile crane AOV 600 including a crane base 605 and a gantry component 610 rotatably mounted to the crane base 605. While the mobile crane AOV 600 is provided as an example of an AOV with construction applications, the AOV 110 may include any type of construction vehicle known to those skilled in the art, such as excavators, wheel loaders, backhoe loaders, motor graders, pavers, cement mixers, and the like. The mobile crane AOV 600 includes a sensor assembly configured for multi-sensor vehicle component orientation measurement, including a first RTK GPS transceiver 225 mounted to the crane base 605 (e.g., the vehicle body 205) and a second RTK GPS transceiver 230 mounted to the gantry component 610 (e.g., the pivotable vehicle component 235). The mobile crane AOV 600 may perform vehicle path planning and execute movement operations based on real-time feedback from the first RTK GPS transceiver 225 and the second RTK GPS transceiver 230 indicative of a relative angle of rotation between the crane base 605 and the gantry component 610, as discussed herein.

In the case of the mobile crane AOV 600, the angle of rotation between the crane base 605 and the gantry component 610 is associated with rotation of a cargo-carrying component for loading and unloading cargo by the AOV 600. For example, when the mobile crane AOV 600 is lifting cargo (e.g., construction materials), a location of the cargo in the physical environment can be calculated based on the angle of rotation of the gantry component 610 and an extension distance of a crane boom (e.g., a telescoping or folding arm). As will be discussed herein, a controller of the mobile crane AOV 600 can monitor the angle of rotation of the gantry component 610 to modify planned movements of the AOV 600 according to characteristics of the AOV 600 and/or the environment. In some instances, the controller may be configured to limit rotation of the gantry component 610, such as to avoid colliding the cargo with a structure or another AOV 110.

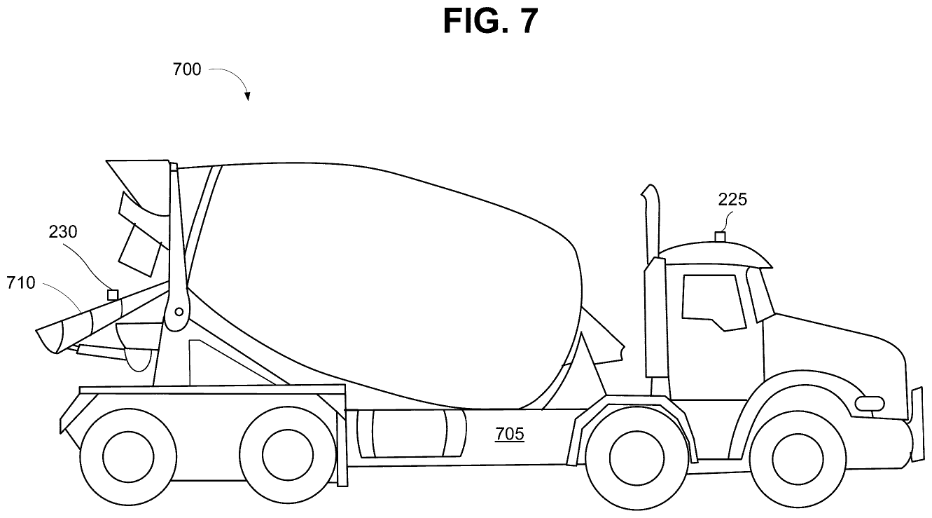

FIG. 7 illustrates a perspective view of yet another exemplary design of the AOV 110. Similar to the mobile crane AOV 600 of FIG. 6, the AOV of FIG. 7 is a cement mixer AOV 700 with applications in the construction industry. The cement mixer AOV 700 includes a truck body 705 and a cement discharge chute 710 rotatably mounted to the truck body 705. The cement mixer AOV 700 includes a sensor assembly configured for multi-sensor vehicle component orientation measurement, including a first RTK GPS transceiver 225 mounted to the truck body 705 (e.g., the vehicle body 205) and a second RTK GPS transceiver 230 mounted to the cement discharge chute 710 (e.g., the pivotable vehicle component 235). The cement mixer AOV 700 may perform vehicle path planning and execute movement operations based on real-time feedback from the first RTK GPS transceiver 225 and the second RTK GPS transceiver 230 indicative of a relative angle of rotation between the truck body 705 and the cement discharge chute 710, as discussed herein.

The cement discharge chute 710 may be rotatable about the truck body 705 in a first dimension (e.g., about a vertical axis) and/or in a second dimension (e.g., about a horizontal axis). The cement discharge chute 710 may further include an extensible component to vary a length of the chute 710 for delivering cement to a target location. The controller of the AOV 700 may use the relative angle of rotation between the truck body 705 and the cement discharge chute 710 to modify planned movements of the AOV 700, including re-positioning the cement discharge chute 710, in order to deliver cement to the target location. It should be noted that in some embodiments, the orientation measurement system can determine an orientation of a cement truck boom pump according to the principles described herein.

Those skilled in the art will envision additional examples of AOVs 110 with applications in the fields of agriculture, mining, construction, forestry, and/or transportation. Aspects of the AOVs discussed herein with reference to FIGS. 1-7 may be combined, modified, or adapted in order to perform autonomous operations within the scope of this disclosure.

### Example Multi-Sensor Vehicle Component Orientation Measurement

The AOV 110 may autonomously perform a vehicle movement based on detected vehicle component orientation data. The AOV 110 may be any AOV of any of the previous figures, such as the pile driving AOV 200, the truck AOV 400, the tractor AOV 500, the mobile crane AOV 600, the cement mixer AOV 700, or any other autonomous off-road vehicle known to those skilled in the art. FIG. 8 illustrates steps of a method 800 for multi-sensor vehicle component orientation measurement and vehicle movement. The method 800 may be executed by a controller (e.g., the control system 330 or components thereof) to generate control signals which cause the AOV 110 to perform one or more autonomous operations as described herein. Although the following description refers to a GPS-based implementation of the method 800 for discussion purposes, it will be understood by those skilled in the art that the method 800 may utilize any global navigation satellite system (GNSS) technology including GLONASS, Galileo, Beidou, QZSS, and the like.

The controller initially receives sensor data from a sensor array of the AOV 110 (e.g., the sensor array 310). Receiving the sensor data includes receiving 805 first location information from a first RTK GPS transceiver (e.g., the first RTK GPS transceiver 225) and receiving 810 second location information from a second RTK GPS transceiver (e.g., the second RTK GPS transceiver 230). The first RTK GPS transceiver 225 and the second RTK GPS transceiver 230 are configured to detect their respective locations (or the locations of one or more receive antennae connected to the transceivers) based on GPS signals received from a plurality of GPS satellites. The first RTK GPS transceiver 225 and the second RTK GPS transceiver 230 may generate first location information and second location information such that the first location information includes geographic coordinates associated with the first RTK GPS transceiver 225 and the second location information includes geographic coordinates associated with the second RTK GPS transceiver 230. In certain embodiments, each RTK GPS transceiver may automatically transmit location information to be received by the controller. In other embodiments, the controller may query the RTK GPS transceivers to access the first location information and the second location information. The controller may query the RTK GPS transceivers at periodic intervals, or on an as-needed basis (e.g., after the AOV has executed a movement operation according to a path plan).

The first location information and the second location information may include geographic coordinates indicative of the present locations of the first RTK GPS transceiver 225 and the second RTK GPS transceiver 230, respectively. The first RTK GPS transceiver 225 and the second RTK GPS transceiver 230 may determine the first location information and the second location information by trilateration amongst three or more GPS satellites. The geographic coordinates may identify each location globally (e.g., as a point on the Earth expressed in the geographic coordinate system (GCS)) or locally (e.g., in relation to a local base station representing a fixed point in the environment). The geographic coordinates may have a location accuracy of at least 10 meters, at least 1 meter, at least 10 centimeters, or at least 1 centimeter.

A local base station (e.g., the local base station 120) may be, for example, a radio transceiver with GPS-receive capabilities which is external to the AOV 110. The local base station 120 is communicatively connected to the controller of the AOV 110, such as by a radio frequency (RF) module (e.g., the RF module 125) configured to transmit at very high frequency (VHF) or ultra-high frequency (UHF) radio bands. Alternatively, the local base station 120 may be connected to the AOV 110 via the network 160. The controller receives 815 correction information from the local base station 120.

The local base station 120 provides a fixed reference point in the environment of the AOV 110 (e.g., on a worksite). The location of the local base station 120 may be determined with a high degree of accuracy (e.g., accurate to at least 1 centimeter or accurate to at least one millimeter). The local base station 120 may transmit correction information including, for example, highly accurate geographic coordinates of the local base station 120, and/or a geographic offset for applying a correction factor to the first location information and the second location information. The controller of the AOV 110 may apply the correction information to the first location information and the second location information to obtain adjusted first coordinates and adjusted second coordinates, the adjusted first coordinates and the adjusted second coordinates indicative of highly accurate location information corresponding to the first RTK GPS transceiver 225 and the second RTK GPS transceiver 230.

The controller accesses 820 (e.g., receives) the first location information, the second location information, and the correction information to determine 825 a first heading corresponding to the vehicle body 205 and determine 830 a second heading corresponding to the pivotable vehicle component 235. The first heading and the second heading are vectors indicative of a direction and a distance of the vehicle body 205 or the pivotable vehicle component 235 from the local base station 120 in the physical environment.

The first heading and the second heading may be expressed in terms of vector components (e.g., in a 2×2 or 2×3 matrix) or as a magnitude and direction (e.g., by one or more heading angles), with the local base station 120 as the vectors' point of origin. In some cases, the first heading and the second heading may be two-dimensional vectors which exist in a common plane (e.g., a horizontal plane approximating the surface of the Earth in a local area). In other cases, the first heading and the second heading may be three-dimensional vectors having an additional vector component (e.g., a vertical component indicating altitude of the vehicle body 205 or the pivotable vehicle component 235). Depending on the size and complexity of the physical environment of the AOV 110 (e.g., ground type, slope grade, obstacle information, or other data about a worksite), the controller can map three-dimensional heading vectors onto a common plane (e.g., the horizontal plane) for ease of comparison.

The controller uses the first heading and the second heading to determine 835 an orientation (e.g., a third heading) of the pivotable vehicle component 235 relative to vehicle body 205. The orientation is a vector which may be calculated as the difference of the first heading and the second heading. Notably, the orientation vector is independent of the base station 115 location, instead having its origin at the adjusted first coordinates (e.g., highly accurate location) of the vehicle body 205. The controller autonomously performs 840 a vehicle movement of the AOV 110 based on the determined orientation, such as via a planned movement modification operation executed by the planned movement modification module 375, discussed below.

### Example Planned Movement Modification Operation

Returning to FIG. 3B, the planned movement modification module 375 is configured to modify in real-time the planned movements to be performed by the AOV 110 based on the original motion plans described in subroutines stored as planned movement data 338. In some embodiments, based on detected characteristics of the AOV 110 and/or the environment 100 (e.g., the orientation of the pivotable vehicle component 235 as determined by the method 800), the planned movement modification module 375 may modify the planned movements to be performed by the AOV 110 in connection with one or more of the autonomous operations described herein (e.g., autonomous end effector positioning operation, autonomous pile pick up operation, autonomous pile loading operation, autonomous pile positioning operation, autonomous pile driving operation).

The characteristics of the AOV 110 and/or the environment 100 may be detected based on one or more sensors of the sensor array 310 of the AOV 110. For example, the one or more sensors may include the first RTK GPS transceiver 225, the second RTK GPS transceiver 230, a lidar sensor, a radar sensor, a camera, and the like. The characteristics of the AOV 110 and/or the environment 100 may also be detected based on other data. For example, the characteristics may be detected based on the pile plan data 334 of the pile plan map, obstacle data 336 generated by the obstacle mapping module 390, quality control condition data 340, sensor data 337, data received from an operator via interface module 342, and the like.

The detected characteristics of the environment 100 may include a ground type, a slope grade, obstacle information, or weather information. Ground type may refer to a detected (e.g., using sensors) subsurface geological composition. For example, the ground type characteristic may indicate if pile driving at the target location will encounter rock, mud, and the like. The obstacle information may refer to the obstacle data 336 received from the obstacle mapping module 390 and indicating obstacles in the environment 100 in a nearby vicinity of the target location.

The detected characteristics of the AOV 110 may include an orientation of the pivotable vehicle component 235 relative to the vehicle body 205 as determined by the method 800, a ratio of the structural load on one or more components (e.g., articulated arm, drive system, end effector, and the like) of the AOV 110 and respective predetermined tolerance limits, an operational efficiency rating of the AOV 110, and the like.

Based on the detected characteristics of the AOV 110 and/or the environment 100, the planned movement modification module 375 may modify one or more planned movements of the AOV 110. The control system 330 may generate planned movements for one or more components 322 of the AOV 110 for performing the various operations associated with, e.g., autonomously loading or unloading cargo, autonomously positioning the vehicle body 205 and pivotable vehicle component 235, and autonomously maneuvering the AOV 110 through a worksite.

As explained previously, the planned movement data 338 may include subroutines defining original motion plans for the AOV 110 for the various autonomous operations associated with autonomous pile driving. In the case of the pile driving AOV 200, based on the subroutines, the control system 330 (e.g., the pile loading module 365, the pile positioning module 368, and/or the pile driving module 370) may generate planned movements for one or more components 322 of the AOV 200 for performing the various autonomous operations associated with, e.g., autonomously positioning the end effector to pick up a pile, autonomously picking up the pile with the end effector, autonomously loading a picked up pile into an end effector for pile driving, autonomously positioning the pile based on a target location, autonomously driving the pile, and the like.

For example, the pile loading module 365 may generate the planned movements for autonomously positioning the end effector to face a pile, autonomously pick up the pile with the end effector, and/or autonomously load the picked up pile into a driving tool, based on the corresponding subroutines defining the original motion plans in the planned movement data 338. The planned movements may be generated based on the detected orientation and location of a selected or identified pile that may be placed on the ground, in a basket of piles placed on the pile driving AOV 200, in a carriage of piles pulled by the AOV 200, or in a pile distribution vehicle (e.g., another AOV 110) that is separate from the AOV 200. The original planned movement may also be based on the type of the end effector (e.g., magnetic gripper, electromechanical gripper, etc.).

Based on the detected characteristics of the AOV 110 and/or the environment 100, the generated planned movements may be modified by the planned movement modification module 375. For example, in the case of the pile driving AOV 200, if the detected location and orientation of the pile (e.g., in a basket, on the ground, etc.) is such that the end effector cannot be positioned to face a predetermined portion of the pile (e.g., because the predetermined portion is out of reach of the end effector based on the movable range of the end effector), the planned movement modification module 375 may determine one or more planned movement modifications (e.g., actuate the driving system to move the AOV 200 closer to the pile, actuate components of the articulated arm and the end effector to drag the pile on the ground to reposition or reorient the pile in a desired manner) so that the AOV 200 can autonomously position the end effector to face the pile in a desired manner. As another example, based on the detected pile type or pile size, the planned movement modification module 375 may determine one or more planned movement modifications (e.g., position the end effector to pick up the pile in a different manner) so that the AOV 200 can autonomously position the end effector to face the pile in a manner that is based on the pile type or pile size. As another example, based on the detected ground slope grade or obstacle information, the planned movement modification module 375 may determine one or more planned movement modifications (e.g., reduce or modify movable range of the articulated arm and the end effector) so that the AOV 200 can autonomously position the end effector to face the pile in a desired manner while avoiding the obstacles, maintaining operation of the AOV 200 within its structural load limits, maintaining AOV 200 stability and traction, and the like.

After picking up the pile, the pile positioning module 368 may generate the planned movements for autonomously positioning the pile at the target location, based on the corresponding subroutine defining the original motion plan in the planned movement data 338. The planned movements may be generated based the target location specified by an operator or based on the pile plan map. Based on the detected characteristics of the AOV 200, the pile, and/or the environment 100, the generated planned movements may be modified by the planned movement modification module 375. For example, if based on sensor data the target location is determined to be rocky (thereby preventing the pile from being driven into the ground at the target location), the planned movement modification module 375 may determine one or more planned movement modifications so that the autonomous pile driving for the target location can be completed in an acceptable manner. For example, the planned movement modification module 375 may display a notification to an operator indicating that the target location is unfit for pile driving. The planned movement modification module 375 may, based on sensor data, further generate a color-coded map indicating suitability of alternate locations within a predetermined range or radius of the target location where the pile may be driven instead. The user may select an alternate location from the map and the planned movement modification module 375 modify the planned movement to position the pile such that a lower end of the pile is at a predetermined height above the ground at the alternate location. In some embodiments, this process may be autonomous or semi-autonomous. For example, the AOV 110 may simply notify the user of the change to the target location and show the updated location on the map where the pile is to be driven instead. As another example, the system may ask for the user's approval before proceeding with the pile driving at the updated location. As another example, if the updated location meets certain criteria (e.g., being within a threshold distance of the original target location), the system may proceed with the pile driving at the updated location fully autonomously without any user intervention. The system may further update the pile plan map data 334 to indicate the updated location.

After positioning the pile at the target (or updated) location, the pile driving module 370 may generate the planned movements for autonomously driving the pile into the ground at the target location based on the corresponding subroutine defining the original motion plan in the planned movement data 338. The planned movements may be generated based on driving the pile with, e.g., default parameters for a driving force, a driving angle, a driving duration, a driving pattern, and/or a driving speed. Based on the detected characteristics of the AOV 200, the pile, and/or the environment 100, the generated planned movements may be modified by the planned movement modification module 375. For example, based on the detected characteristics of the pile (e.g., type of pile, size or shape of pile), the planned movement modification module 375 may determine one or more planned movement modifications by modifying parameters for the driving force, the driving angle, the driving duration, the driving pattern, and/or the driving speed to achieve a desired result. As another example, based on the detected characteristics of the pile, the planned movement modification module 375 may determine a new location based on the pile plan map wherein the pile having the detected characteristics can be driven and determine one or more planned movement modifications (e.g., planned movement modifications for autonomous navigation, autonomous pile positioning, and autonomous pile driving at the new location) to drive the pile at the new location per the pile plan map. As another example, based on the detected characteristics of the environment (e.g., ground firmness, ground composition, ground slope), the planned movement modification module 375 may determine one or more planned movement modifications by modifying parameters for the driving force, the driving angle, the driving duration, the driving pattern, and/or the driving speed to achieve a desired result. As another example, based on the detected characteristics of the AOV 200 (e.g., structural load limits, operating efficiency), the planned movement modification module 375 may determine one or more planned movement modifications by modifying parameters for the driving force, the driving angle, the driving duration, the driving pattern, and/or the driving speed to achieve a desired result.

The pile driving module 370 may drive the pile into the ground at the target location based at least in part on performance of the one or more modified planned movements.

Performance of the one or more modified planned movements may be autonomous, semi-autonomous, or manual. For example, when repositioning the pile on the ground so that it can be picked up by the end effector, the AOV 200 may automatically perform modified planned movements like driving the AOV 200 by operating the drive system, dragging the pile on the ground by actuating the articulated arm to reorient or reposition the pile such that it can be picked up by the end effector, turning the pile around, and the like. In an alternate embodiment, some of the modified planned movements may be performed after confirmation from a user. For example, the user may be notified of one or more modified planned movements and required to provide an input on an interface to confirm the modified planned movement should be performed.

Although the foregoing description relates to modification of planned movement operations by the pile driving AOV 200 for discussion purposes, it will be understood that the techniques discussed herein are generally applicable to any AOV 110, including at least the truck AOV 400, the tractor AOV 500, the mobile crane AOV 600, and the cement mixer AOV 700 of FIGS. 4-7. Those skilled in the art will envision additional examples of modifying planned movement operations by any AOV 110 within the scope of this disclosure.

### Example Computer System

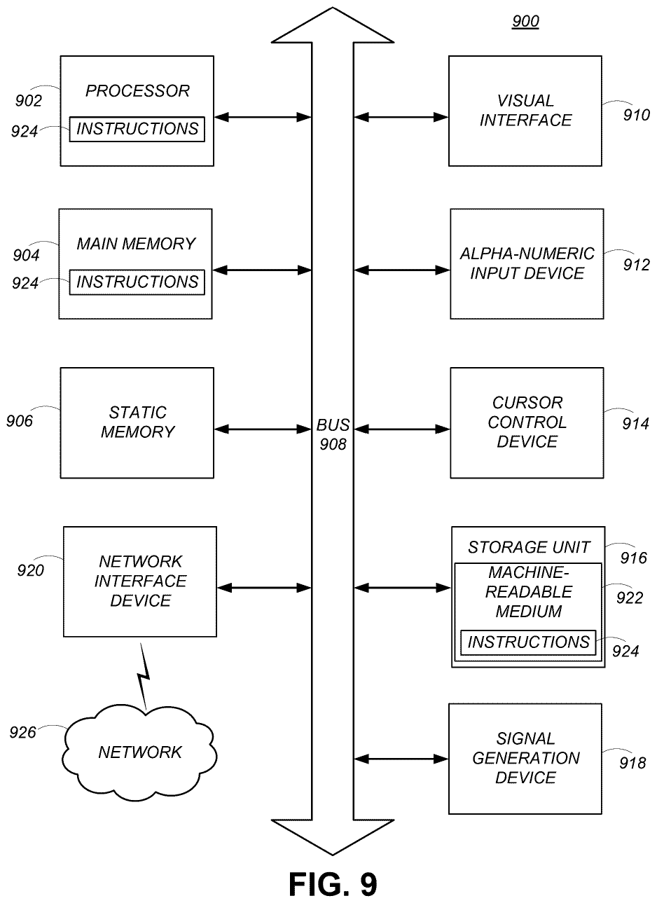

FIG. 9 is a block diagram illustrating components of an example machine for reading and executing instructions from a machine-readable medium, in accordance with one or more example embodiments.

FIG. 9 is a block diagram illustrating components of an example machine for reading and executing instructions from a machine-readable medium, in accordance with one or more example embodiments. Specifically, FIG. 9 shows a diagrammatic representation of one or more of the central server 130 of FIG. 1, the client device 140 of FIG. 1, and the control system 330 of FIGS. 3A-3B in the example form of a computer system 900.

The computer system 900 can be used to execute instructions 924 (e.g., program code or software) for causing the machine to perform any one or more of the methodologies (or processes) or modules described herein. In alternative embodiments, the machine operates as a standalone device or a connected (e.g., networked) device that connects to other machines. In a networked deployment, the machine may operate in the capacity of a server machine or a client machine in a client-server network environment, or as a peer machine in a peer-to-peer (or distributed) network environment.

The machine may be a server computer, a client computer, a personal computer (PC), a tablet PC, a set-top box (STB), a smartphone, an internet of things (IoT) appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute instructions 924 to perform any one or more of the methodologies discussed herein.

The example computer system 900 includes one or more processing units (generally processor 902). The processor 902 is, for example, a central processing unit (CPU), a graphics processing unit (GPU), a digital signal processor (DSP), a control system, a state machine, one or more application specific integrated circuits (ASICs), one or more radio-frequency integrated circuits (RFICs), or any combination of these. The computer system 900 also includes a main memory 904. The computer system may include a storage unit 916. The processor 902, memory 904, and the storage unit 916 communicate via a bus 908.

In addition, the computer system 900 can include a static memory 906, a graphics display 910 (e.g., to drive a plasma display panel (PDP), a liquid crystal display (LCD), or a projector). The computer system 900 may also include an alphanumeric input device 912 (e.g., a keyboard), a cursor control device 917 (e.g., a mouse, a trackball, a joystick, a motion sensor, or other pointing instrument), a signal generation device 918 (e.g., a speaker), and a network interface device 920, which also are configured to communicate via the bus 908.

The storage unit 916 includes a machine-readable medium 922 on which is stored instructions 924 (e.g., software) embodying any one or more of the methodologies or functions described herein. For example, the instructions 924 may include the functionalities of modules of one or more of the central server 130 of FIG. 1, the client device 140 of FIG. 1, and the control system 330 of FIGS. 3A-3B. The instructions 924 may also reside, completely or at least partially, within the main memory 904 or within the processor 902 (e.g., within a processor's cache memory) during execution thereof by the computer system 900, the main memory 904 and the processor 902 also constituting machine-readable media. The instructions 924 may be transmitted or received over a network 926 via the network interface device 920.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

1. An autonomous vehicle (AV), comprising:
a vehicle body comprising a first real-time kinematic positioning (RTK) global positioning system (GPS) receiver with two or more antennas;
a vehicle component comprising a second RTK GPS receiver with two or more antennas, the vehicle body and the vehicle component coupled via a pivoting joint; and
a controller configured to:
access first heading information received from the first RTK GPS receiver and second heading information received from the second RTK GPS receiver;
determine a rotation of the vehicle component around the pivoting joint relative to the vehicle body using an angular difference between the first heading information and the second heading information; and
autonomously perform a vehicle movement based on the determined rotation.

2. The autonomous vehicle of claim 1, wherein accessing first heading information received from the first RTK GPS receiver and second heading information received from the second RTK GPS receiver comprises:
receiving, from a radio frequency (RF) module communicatively coupled to the controller, a first direction vector indicating a direction of the first RTK GPS receiver and a second direction vector indicating a direction of the second RTK GPS receiver.

3. The autonomous vehicle of claim 2, wherein the first heading information is determined by:
accessing predetermined coordinates indicating a location of a local base station;
applying correction information to first coordinates of the first RTK GPS receiver to obtain adjusted first coordinates;
calculating a difference between the adjusted first coordinates and the predetermined coordinates of the local base station to obtain a relative position of the first RTK GPS receiver; and
determining the first heading information corresponding to the vehicle body based on the relative position of the first RTK GPS receiver.

4. The autonomous vehicle of claim 3, wherein the second heading information is determined by:
applying the correction information to second coordinates of the second RTK GPS receiver to obtain adjusted second coordinates;
calculating a difference between the adjusted second coordinates and the predetermined coordinates of the local base station to obtain a relative position of the second RTK GPS receiver; and
determining the second heading information corresponding to the vehicle body based on the relative position of the second RTK GPS receiver.

5. The autonomous vehicle of claim 4, wherein determining the rotation of the vehicle component relative to the vehicle body using the first heading information and the second heading information comprises:
calculating a vector representation of the rotation of the vehicle component relative to the vehicle body by subtracting a vector representation of the first heading information from a vector representation of the second heading information; and
calculating an angle of the vector representation of the rotation of the vehicle component in a first plane, the angle indicating an angle of rotation of the vehicle component relative to the vehicle body.

6. The autonomous vehicle of claim 1, wherein the vehicle component is a cargo-carrying component rotatable about an axis of the vehicle body.

7. The autonomous vehicle of claim 6, wherein the vehicle component is an arm, boom, trailer, baler, gantry, or chute.

8. A method of operating an autonomous vehicle (AV), the method comprising:
receiving, from a first RTK GPS receiver with two or more antennas of a vehicle body, first heading information;
receiving, from a second RTK GPS receiver with two or more antennas of a vehicle component, second heading information, wherein the vehicle component is coupled to the vehicle body via a pivoting joint;
determining a rotation of the vehicle component around the pivoting joint relative to the vehicle body using an angular difference between the first heading and the second heading; and
autonomously performing a vehicle movement based on the determined rotation.

9. The method of claim 8, wherein receiving first heading information from the first RTK GPS receiver and receiving second heading information from the second RTK GPS receiver comprises:
receiving a first direction vector indicating a direction of the first RTK GPS receiver and a second direction vector indicating a direction of the second RTK GPS receiver.

10. The method of claim 9, wherein the first heading information is determined by:
accessing predetermined coordinates indicating a location of a local base station;
applying correction information to first coordinates of the first RTK GPS receiver to obtain adjusted first coordinates;
calculating a difference between the adjusted first coordinates and the predetermined coordinates of the local base station to obtain a relative position of the first RTK GPS receiver; and
determining the first heading information corresponding to the vehicle body based on the relative position of the first RTK GPS receiver.

11. The method of claim 10, wherein the second heading information is determined by
applying the correction information to second coordinates of the second RTK GPS receiver to obtain adjusted second coordinates;
calculating a difference between the adjusted second coordinates and the predetermined coordinates of the local base station to obtain a relative position of the second RTK GPS receiver; and
determining the second heading information corresponding to the vehicle body based on the relative position of the second RTK GPS receiver.

12. The method of claim 11, wherein determining the rotation of the vehicle component relative to the vehicle body using the first heading information and the second heading information comprises:
calculating a vector representation of the rotation of the vehicle component relative to the vehicle body by subtracting a vector representation of the first heading information from a vector representation of the second heading information; and
calculating an angle of the vector representation of the rotation of the vehicle component in a first plane, the angle indicating an angle of rotation of the vehicle component relative to the vehicle body.

13. The method of claim 8, wherein the vehicle component is a cargo-carrying component rotatable about an axis of the vehicle body.

14. A system comprising:
a processor; and
a non-transitory computer-readable storage medium comprising stored instructions, the instructions when executed by the processor cause to processor to perform operations comprising:
receiving, from a first RTK GPS receiver comprising two or more antennas of a vehicle body, first heading information;
receiving, from a second RTK GPS receiver comprising two or more antennas of a vehicle component, second heading information, wherein the vehicle component is coupled to the vehicle body via a pivoting joint;
determining a rotation of the vehicle component around the pivoting joint relative to the vehicle body using the first heading information and the second heading information; and
autonomously performing a vehicle movement based on the determined rotation.

15. The system of claim 14, wherein receiving first heading information from the first RTK GPS receiver and receiving second heading information from the second RTK GPS receiver comprises:
receiving a first direction vector indicating a direction of the first RTK GPS receiver and a second direction vector indicating a direction of the second RTK GPS receiver.

16. The system of claim 15, wherein the first heading information is determined by corresponding to the vehicle body based on the first location information and the correction information comprises:
accessing predetermined coordinates indicating a location of a local base station;
applying correction information to first coordinates of the first RTK GPS receiver to obtain adjusted first coordinates;
calculating a difference between the adjusted first coordinates and the predetermined coordinates of the local base station to obtain a relative position of the first RTK GPS receiver; and
determining the first heading information corresponding to the vehicle body based on the relative position of the first RTK GPS receiver.

17. The system of claim 16, wherein the second heading information is determined by:
applying the correction information to second coordinates of the second RTK GPS receiver to obtain adjusted second coordinates;
calculating a difference between the adjusted second coordinates and the predetermined coordinates of the local base station to obtain a relative position of the second RTK GPS receiver; and
determining the second heading information corresponding to the vehicle body based on the relative position of the second RTK GPS receiver.

18. The system of claim 17, wherein determining the rotation of the vehicle component relative to the vehicle body using the first heading information and the second heading information comprises:
calculating a vector representation of the rotation of the vehicle component relative to the vehicle body by subtracting a vector representation of the first heading information from a vector representation of the second heading information; and
calculating an angle of the vector representation of the rotation of the vehicle component in a first plane, the angle indicating an angle of rotation of the vehicle component relative to the vehicle body.

19. The system of claim 14, wherein the vehicle component is a cargo-carrying component rotatable about an axis of the vehicle body.

20. An autonomous vehicle (AV), comprising:
a vehicle body comprising a first real-time kinematic positioning (RTK) global positioning system (GPS) receiver with two or more antennas;
a vehicle component comprising a second RTK GPS receiver with two or more antennas, the vehicle body and the vehicle component coupled via a prismatic joint; and
a controller configured to:
access first heading information received from the first RTK GPS receiver with two or more antennas and second heading information received from the second RTK GPS receiver with two or more antennas;
determine a rotation of the vehicle component around the pivoting joint relative to the vehicle body using an angular difference between the first heading information and the second heading information and autonomously perform a vehicle movement based on the determined rotation.
